(19) United States
(12) Patent Application Publication
(10) Pub. No.: US 2007/0030259 A1
(43) Pub. Date: Feb. 8, 2007

(54) Method and arrangement for improving the functions of the display unit of a portable device

(75) Inventor: Juha Karttunen, Espoo (FI)

Correspondence Address: HARRINGTON & SMITH, LLP, 4 RESEARCH DRIVE, SHELTON, CT, 06484-6212, US

(73) Assignee: NOKIA CORPORATION, Espoo (FI)

(21) Appl. No.: 10/576,536

(22) PCT Filed: Nov. 15, 2004
(86) PCT No.: PCT/FI04/50165

§ 371 Date: Apr. 19, 2006

(30) Foreign Application Priority Data
Nov. 17, 2003 (FI) 20035211

(51) Int. Cl. G09G 5/00

(52) U.S. Cl. 345/204

(57) ABSTRACT

The invention relates to an arrangement and method for improving a display unit (101, 201, 301) of a portable device. In the method, in the surroundings of the display unit (101, 201, 301), there are arranged light units (102a, 102b, 102c, 102d, 102e, 102f, 102g, 102h, 202a, 202b, 202c, 202d, 202e, 202f, 302a, 302b, 302c, 302d, 302e, 302f), which are controlled through a light driver (304) with respect to the view shown in the display unit (101, 201, 301). More information to the view shown in the display unit (101, 201, 301) is indicated by means of light units (102a, 102b, 102c, 102d, 102e, 102f, 102e, 102f, 102g, 102h, 202a, 202b, 202c, 202d, 202e, 202f, 302a, 302b, 302c, 302d, 302e, 302f).

The invention relates to improving the functions of the display unit of a small portable device and to making said functions more versatile.

When developing portable, mobile devices, the restricted size of the devices must always be taken into account. Applications and functions that can be easily used in larger, stationary devices cannot generally be directly transferred to mobile devices, but certain things must be taken into account in order to maintain the handy nature of the small-sized device. For instance, it is not sensible to run in a portable device applications that require a high processing power, because the functions become so slow that in the end, they cannot be run in practice. The functions of small devices must be adjusted to be represented in a fairly small display and to be run by a fairly low processing power. In addition, the number of fixed data input elements provided in mobile devices is typically very limited, although more versatile input elements can be added in some devices as accessories.

One of the factors restricting the usability of a portable device is the size of the display unit. The user obtains a lot of information through the display unit, because for a healthy person, vision is typically the strongest sense, primarily used for sense perception. Thus the interface between a human being and a display unit is an essential factor when designing the device. Typically the elements that are located in the same interface with the display unit are data input elements that can be keys, an input panel receiving pen input, a mouse, a microphone receiving voice input, and so on. When speaking of portable devices, they must first of all be fairly small in size. Therefore also the size of the display unit installed in the device is very limited. Thus small devices are typically used only for searching or producing essential, necessary information, and a more detailed survey of this information is carried out later on by means of more effective devices. For example, if a portable device can be used for establishing a connection according to the WAP (Wireless Application Protocol) to the user's email mailbox, the portable device can be used for browsing email messages anywhere. Generally, however, it is recommendable that the detailed survey of attached files is carried out later on by means of a more effective device, where the application software runs faster, and where more data can be shown simultaneously on larger display screen in more detail and in a size where it is sensible for the user to observe or process the data of an attached file. However, it is not always possible to put said survey off to a later moment, but it must be carried out by a small device, in a restricted operational environment.

More and more functions that become more and more demanding are realized by small portable devices. In particular, the features often required of the display unit of a device are improved quality, power, resolution and update rate. For example the entertaining games included in devices are continuously developed, and the simplest game applications do not satisfy users anymore, not even in small devices, but the games are often versatile and fast operated. Generally a small display sets its limits for representing rapidly altering and changing details. In games, the drawbacks of a small display area are demonstrated for instance so that the player is destroyed by a threat that is located outside the view shown on the display, because it in that case cannot be detected by the user. Generally the size of a small display becomes a problem also in a case where under observation there is a larger uniform entity that cannot be shown sufficiently accurately on a small display. Said entity that can be for example the map of a town can be displayed in suitable portions in order to distinguish the details. Here the problem is that the portions displayed for the user remain as fractions, and it is often impossible for the user to form a good overall view.

In the prior art, the problems of a small display have been solved by increasing the size of the display unit and by improving the accuracy. When increasing the accuracy of a display, for example resolution and update rate, it must be observed that the price of a small display unit must stay within a reasonable range. Moreover, when the display unit itself already is small, the development of quality is useful only up to a point where the human eye can detect the improvements on the screen. As regards the increasing of the display unit size, the limiting factor is the size of the device itself, which should be kept small in order to make the device feasible in a portable and mobile application. When increasing the size of the display unit, it should also be taken into account that the expenses should stay moderate, and the unit should not excessively increase the total weight of the device. In addition, a wider field to be updated further requires a higher power in processing, in the display driver and in updating, in order to maintain the picture quality at least as good as before. Thus a mere increase in the display unit size does not solve the problems of the prior art, but the elimination of problems by increasing the display unit size would require changes in other blocks, too. As regards said changes, they would in turn cause additional problems and things to be taken into account, such as additional expenses, need for space and further facilities for other functional blocks.

The objective of the invention is to improve the usability and features of a portable mobile device. One objective of the invention is to make the features of the display unit of a portable device more versatile. Another objective of the invention is to minimize the drawbacks occurring in the prior art solutions and to decrease the harmful effects caused by them. Yet another objective of the invention is to improve the display unit of a small device and to make it more versatile in a simple way.

The objective is achieved so that of the information left outside the view of the display unit, there is produced an indication for the user in relation to the view by creating a visual stimulus that can be perceived.

The invention is characterized by what is set forth in the characterizing parts of the independent claims. Another embodiments of the invention are described in the dependent claims.

According to an embodiment of the invention, the portable device includes a display unit, and in the surroundings thereof, there are arranged light units for indicating more information to the view represented on the display screen. In addition, a portable device according to an embodiment of the invention is provided with a light driver for controlling the light units. In a method according to an embodiment of the invention for improving the view of the display unit of a portable device, in the surroundings of the display unit, there are arranged light units, the light units are controlled through a light driver in relation to the view represented on the display unit screen, and more information to the view represented on the display unit is indicated by means of the light units.

For an entity to be shown at the same time, applications represented in small portable devices would often require a remarkably larger space than what is available on the display of the small device, and therefore only part of said entity can be shown at a time, and part of the application or of a function connected to said application is hidden from view but still functionally continues even outside the view shown on the display. Typically the application element, function, object or target left outside the view forms part of the application or of the represented data in similar fashion as the shown elements: the elements left outside the view are available and have an effect to the application in a similar way as the visible elements shown on the display screen. According to an embodiment of the invention, there is formed to the user a visual stimulus that functions as an indication of how the view shown on the display continues outside the view, in the direction of the visual stimulus. The perceived indication affects the user's choices and operations in the current view. For example in game applications, the user has time to react to the approaching situation, when the approaching situation is indicated in advance, so that the user can prepare himself for the situation. The location and/or direction of a situation, information, function or the like, left outside the current view, is typically indicated by controlling the light units arranged around the display, so that there are lighted up those light units that are located in the same direction with respect to the display view as the information to be indicated.

Typically the user actively observes the display view, so that he focuses his eyes in a given detail. Thus the user's eyes are focused on the display, and the details of the display are observed accurately. In order to achieve an accurate visual perception, the eye is focused on a given target. With a healthy, normal human being, the range of accurate vision observed by both eyes simultaneously, i.e. the so-called stereo vision range, is about 30° of the total human field of vision. The total visual field that a human being sees sideways without turning his head can be even more than 180°. The vertical visual field is smaller, about 130°. Outside the accurate vision range, in which the eye(s) is/are focused, there is left a so-called peripheral vision range that is not accurate but still detects movement and change fairly well. Typically the user focuses his vision and accurately observes only one target at a time. Thus the accurate observation of a human being can in the accurate vision range be focused on a very small area. In an embodiment of the invention, the wide visual field of the human eye is made use of so that in the display unit view, there is located a target of observation on which the user has focused his vision, and for the area left outside the view, there is created a visual indication that does not require accurate observation. The described indication created outside the accurate field of observation is observed simultaneously as the eyes are focused on a given target on the display, without having to focus the eyes anew. The indication is typically realized by means of light units, because the glow of lights, their lighting up, turning off, flashing or other light patterns created by adjusting the light units are well detected in a visual range where it is difficult to detect accurate, detailed targets, but where changes and movements are sensed well. An indication created for the visual range left outside the accurate target of observation on which the vision is focused can be generated rapidly, the user detects it easily, and it does not affect the view nor the operation of the application represented in the view. Therefore it is particularly advantageous in rapidly changing scenes, because according to the embodiment, time is not consumed even in focusing the eyes on the indicator placed beside the display unit and again back on the target under observation in the scene, which means that the user is left with more time to react to the next event indicated according to the embodiment. Particularly in games with a fast tempo, it is useful that the user gets the indication rapidly and even without focusing his eyes on said indication, because thus he is left with more time to react.

In general, according to embodiments of the invention there are generated sense stimuli for a wider visual field instead of for instance enlarging the display unit, as is typically done in the prior art solutions. The arrangement according to the invention enables a more natural interaction between the user and the device. However, any large, heavy or expensive improvements in the device or in its blocks are not required. In the arrangement according to embodiments of the invention, there are generated visual sensations, visual hints and feedback also for that range of the visual field that is located outside the accurate vision and is thus less accurate. In the arrangements according to embodiments, the sensation felt by the user and the interaction experienced by him are both improved, and the interaction between the user and the device is made more natural than before.

Embodiments of the invention are described in more detail below with reference to the appended drawings, where

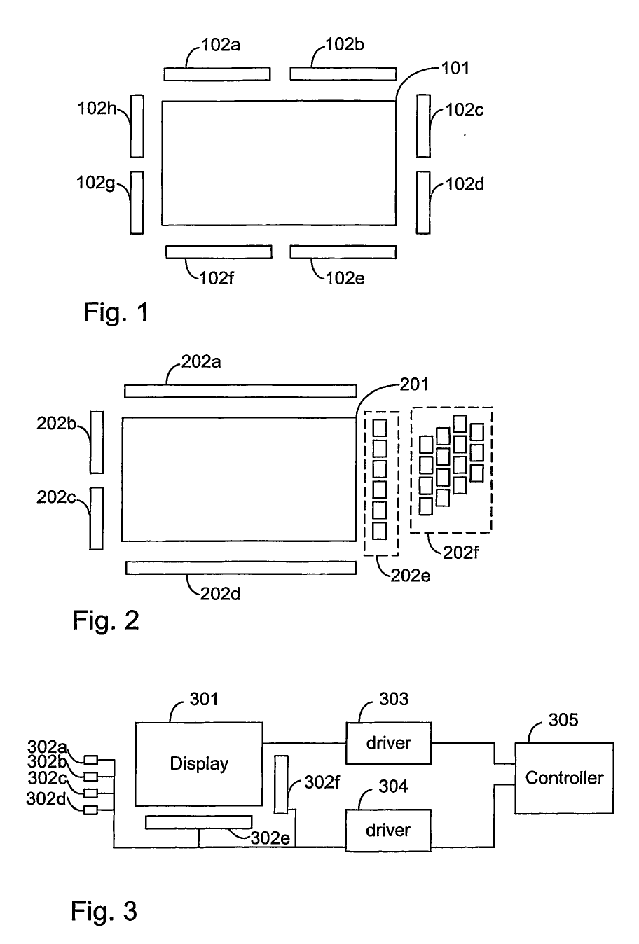

FIG. 1 illustrates an arrangement according to an embodiment of the invention,

FIG. 2 illustrates an arrangement according to an embodiment of the invention, and

FIG. 3 illustrates an equipment according to an embodiment of the invention.

FIG. 1 illustrates an example of a small display unit 101 according to an embodiment of the invention, around which display unit there are arranged light units. In this embodiment, the light units are arranged beside the display unit 101 and spaced evenly, so that on each side of the rectangular display unit 101, there are two light units. The light units are arranged symmetrically on the opposite sides of the display unit 101, so that on one long side of the display unit 101, there are placed two light units 102a and 102b, and on the opposite long side of the display unit 101, there are two similar light units 102f and 102e. Likewise, on one short side of the display unit 101, there are placed two light units 102c and 102d, and on the opposite short side there are respectively placed light units 102h and 102g. According to an embodiment, the number of the light units is at least two, and they are placed on two different sides of the display unit 101, advantageously on the opposite sides. Generally the position of usage of the device is defined for instance with respect to the direction of the view shown in the display unit and/or the location of the input means, and therefore the light units can be arranged in the device so that when the device is in its predetermined normal position of usage, the light units according to an embodiment of the invention are placed at the sides of the display unit, and not above or beneath it.

In an embodiment of FIG. 1, in the display unit 101 there is shown a map datum. Said map datum can be looked up in the display unit from the memory of the device or, in case the device is capable of establishing a connection to the net, the map datum can be downloaded for example from the Internet or from a server in the net. A map datum located in the net can also be observed by means of a browser included in the device. Typically map applications are large and contain a lot of details. A small display unit is generally capable of showing only a small part of the whole system. If the user wants to find a certain location on the map, said location can be indicated to him by showing in the display unit the map datum of said location and of its surroundings. In that case, however, the whole system, such as the location on the map in a larger scale, is generally not clear for the user. According to an embodiment of the invention, the map shown in the display unit is larger than the display unit, in which case part of said map is hidden, or in a way extends outside the view shown in the display unit. The user may search in the map for instance a certain town, a given location, address or another identifiable target. When the display unit represents the city map, and the user wishes to find a location (address) that is not shown in the view of the display unit, it is possible, by means of the light units 102a, 102b, 102c, 102d, 102e, 102f, 102g, 102h adjacent to the display unit 101 to generate a visual stimulus that indicates the user in which direction the searched location is with respect to the view shown in the display unit. The visual stimulus generated by means of the light units according to embodiments can constitute the lighting up or turning off one or several lights, or for instance the lights in a given direction may flash all the more rapidly, the nearer to the view the searched target is located. Also the intensity of the light units can be modified, so that when the searched target is located far away from the view of the display unit 101, the light units located in said direction shine weakly, and their light becomes more bright as the target approaches the view.

According to an embodiment, the view of the display unit 101 can be scrolled in a given direction, for example by means of an arrow key, a mouse or a touch input. If for instance a map datum can be scrolled, and the area under observation is a given restricted area, such as a park, a town or a province, it is possible to indicate, by means of the light units according to an embodiment, in which direction—with respect to the area shown in the display unit—said area extends. The user may scroll the view and thus obtain a better picture of the area as a whole, because in relation to each view, he is given an indication as to in which direction the area continues with respect to the view shown in the display unit. Thus the input fed in by the user results in that the light units are readjusted according to the new view, or according to the input for instance when indicating the direction of the searched target.

FIG. 1 illustrates two light units on each side of the display unit. When necessary, the light units of this embodiment can be used for indicating whether the location in question is the top or bottom part of the side, or respectively whether the location in question is the left or right hand side of the top or bottom side. In addition, the light units of this embodiment can be used for indicating the direction of the display unit angle by means of the light units of two different sides, located nearest to the angle, such as the light units 102b and 102c. Naturally the direction can be indicated all the more accurately, the larger the number of the light units or separately controlled light unit groups that are provided in the surroundings of the display unit.

FIG. 2 illustrates a display unit 201 according to another preferred embodiment of the invention, around which display unit there are arranged light units, so that in the surroundings of each of the long sides of the display unit 201, there is provided one large light unit 202a, 202d. In this embodiment, in the surroundings of one short side there are provided two light units 202b, 202c, and in the surroundings of the other short side, there are provided several light units 202e, 202f. The light units can be adjusted and controlled by means of a light driver in groups, for example so that the light units located on different sides of the display unit are controlled separately. According to an embodiment, each light unit is controlled separately. In the embodiment of FIG. 2, it is for instance possible to control separately the light units 202b and 202c, because thus the direction can be indicated better and more accurately than only by means of one adjustable light unit group located on a given side. Typically small light units form so-called adjustable light unit groups, including several single light units, the operation of which are controlled group wise. According to an embodiment, the light unit groups 202e and 202f of FIG. 2 each form a separately controlled light unit group. According to another embodiment, the light units 202f are further used for creating separately controlled light unit groups so that each light unit column can be controlled separately. One of the resulting advantages is that the light columns can light up to the same rhythm as the target hidden in their direction approaches the display unit 201. In addition, several adjustable light unit groups can be used for creating different light patterns by lighting them up and turning them off in a given rhythm with respect to each other. In addition to the direction of the hidden target, the created light patterns can be used for indicating something of the type or properties of the target. A flashing light may indicate the approaching of a certain type of game creature from the direction of the light, and on the other hand, the quantity of lights can be used for indicating for instance the size or strength of the game creature, or the distance of the target that is searched on a map.

According to an embodiment, the intensity of a single light unit, i.e. the strength of its light, can be adjusted. By adjusting the light intensity, there can be indicated for example the distance, strength or size of the approaching target. In addition, according to an embodiment by the light units there can be created different colors that indicate the quality or functions of the target. For example, in the embodiment of FIG. 2, a game application can be shown in the display unit 201. When a threatening factor of the game application approaches either the game area observed by the user or the target in the display unit 201, the direction of the approaching threat with respect to the display unit can be indicated by lighting the light unit that is located in the approaching direction of the threatening factor. The threat can be indicated for instance by red light, and a possible escape route or a direction that is advantageous for the player can be indicated by green light. In addition, the intensity or number of the light units can be used for indicating the distance of a target, such as the threatening factor in a game, from the view of the display unit 201.

By means of an arrangement according to the embodiment illustrated in FIG. 2, the user is left with enough time to react for example to the approaching of a game-approaching target, because he gets an indication of the target, its approaching direction and possibly also its quality already before the target is even seen in the range of the user display unit 201. Indications that are external to the display unit are extremely efficient, because they give the user essential information connected to the view that is under observation and shown in the display unit. Moreover, the indications can, depending on an embodiment in question, be realized even very simply, in which case the efficiency or power of the arrangement is not essentially consumed in generating the indications according to embodiments. Indicating according to embodiments of the invention can also be used for producing additional stimuli to the user's vision when the target to be indicated is shown on the display. The user only observes a certain display target at a time, which means that the indication of important targets increases their prominence. This is a way to prevent a situation where the user does not detect an important target only because he is intensively concentrated in some other target. For example in game applications, it can typically be very clearly anticipated which target the user observes, and which targets should be useful to indicate according to an embodiment of the invention.

According to another embodiment, in the display unit 201, there can be shown for example text-form data, which the user can scroll, typically at least up and down, in a way known as such. The light units 202e positioned beside the display unit can be controlled separately, or they form several light unit groups that can be controlled separately. By using this kind of separately controlled light units 202e located beside or adjacent to the display unit, or somewhat further in the surroundings thereof, it is possible to indicate for instance at which point of the text area, only part of which can be shown at a time in the display unit, the user is located at each given moment. Thus the light units 202e arranged in the direction of the edge of the display unit 201 describe as a whole the text or other data shown in the view of the display unit, and one single light unit indicates at which point of the whole range the user is located in the vertical direction, or which point of the whole range is shown in the display unit at the moment in question. Respectively, there can be realized indication of the location in the sideways direction with respect to the whole range. When necessary, the sideways oriented and vertical indications according to the example can also be realized simultaneously, in case a simultaneous indication of the directions produces useful information with respect to the data to be presented.

According to an embodiment, a device where several adjustable light unit groups are located in the surroundings of the display unit, the adjustable light units according to the invention can be used for indicating for instance north, or generally directions of the compass. This is advantageous for instance when using map applications and when navigating. According to an embodiment, for instance a GPRS (General Packet Radio Service) device can be used for indicating the points of the compass by means of the light units according to an embodiment of the invention, without having to switch on the display unit proper. This minimizes power consumption, because the light units according to an embodiment of the invention consume essentially less power than the whole display unit. According to another embodiment, the light units are used for producing more information in the three-dimensional view of the display unit, for example in a HMD, head mounted display. This is advantageous above all in applications where the purpose is to give the user sense stimuli in an area of the visual field that is as wide as possible, in order to create between the human being and the device an interaction that is as real and natural as possible.

FIG. 3 illustrates parts of a device according to an embodiment of the invention, which parts are important for the embodiments of the invention. Naturally the device also includes other blocks than those illustrated in FIG. 3, such as data input means, application components, means for establishing a connection and so on. A control unit, i.e. controller 305 takes care of all the functions of the device and controls the device blocks either directly or through another block. Typically the controller 305 contains a processor by means of which the device functions are carried out. The controller 305 transmits to the display driver 303 commands, inquiries and data, according to which the display driver 303 controls the representation of information in the display unit 301. By intermediation of the display driver 303, the controller 305 receives information of the state of the display unit 301. In the controller 305, there are defined the control commands of the light units 302a, 302b, 302c, 302d, 302e, 302f. The light units 302a, 302b, 302c, 302d, 302e, 302f are controlled in relation to the view shown in the display unit 301 at the moment, and the functions of the light units 302a, 302b, 302c, 302d, 302e, 302f are synchronized and controlled with respect to the instantaneous view in the display. The controller 305 transmits the control commands to the light driver 304.

The light units can be realized by means of light emitting diodes (LEDs). A light emitting diode is not a particularly bright light source, but in many embodiments and applications its luminosity is sufficient. Light emitting diodes are monochromatic, i.e. they only produce monochromatic light, one wavelength of light. If colors should be utilized when using monochromatic light emitting diodes, the colors can be realized so that a given light unit group contains different colors of light emitting diodes that can be controlled color by color. Thus, in the group in question, there can be lighted for instance only certain colors of light emitting diodes. Colors can also be introduced in monochromatic light emitting diodes so that on top of given light emitting diodes or light emitting diode groups, there is installed a given colored, light-permeable part, owing to which the radiation emitted from the light emitting diode seems to have a certain color. By arranging light emitting diodes in different colors of controllable groups or rows, different colors can be utilized in the embodiments, although the light emitting diodes themselves are monochromatic. Among the advantages of light emitting diodes, there are their small power consumption and good efficiency. In addition, light emitting diodes have a long working life.

A more developed and versatile light unit is a so-called organic light unit (OLED, Organic Light Emitting Device), where the semiconductor employed in the light emitting diode is an organic polymer. The luminosity of an organic light unit is good, i.e. the emitted light is bright. Moreover, organic light units are durable, light-weight and good both in luminosity and in efficiency. In particular, organic light units can be used for producing radiation with different colors, i.e. the wavelength of the emitted radiation can vary. Consequently, by means of organic light units, also different colors can be utilized in embodiments.

In FIG. 3, in the surroundings of the display unit, there are placed small single light units 302a, 302b, 302c, 302d that are controlled by a light driver 304. According to respective embodiment, the light units are controlled each in turn, all together or in groups of defined sizes. In addition, in the example of FIG. 3, there are illustrated separately controlled light units 302e and 302f. Typically the light units are controlled through the light driver 304 according to control commands generated in the controller 305. The controller 305 also controls the display and operation of the display unit 301 through the display driver 303. The controller 305 includes information of the view that is at each point of time, i.e. instantaneously, shown in the display unit 301, or said information can, when necessary, be requested by intermediation of the display driver 303. In the controller 305, there is defined, on the basis of the view shown in the display unit 301 and the employed application as to which of the light units 302a, 302b, 302c, 302d, 302e and 302f is controlled at each point of time, and how. Typically the controller 305 comprises software means for controlling the light units 302a, 302b, 302c, 302d, 302e and 302f either in groups or one by one, and in order to define the properties of the light units 302a, 302b, 302c, 302d, 302e and 302f, such as color, intensity, duration of illumination, repetitions and so on. The required control data is produced, calculated or defined in the controller 305 according to the display unit application and to the instantaneous view shown in the display unit. Thus the data and the control commands to be transmitted to the light driver 304 are synchronized in the controller 305 with the data shown in the display unit 301. According to an embodiment, in addition to the functions of the light units 302a, 302b, 302c, 302d, 302e and 302f, in the controller 305 there is synchronized a sound pattern according to a given light pattern or a given application, which sound pattern can then be transmitted via a sound driver to be produced for instance through the headphone of the device, or by intermediation of more developed MP (Media Player) or MIDI (musical instrument digital interface) blocks. In addition to the sound property, to the controlling of the light units there can respectively be connected for instance a vibration function with the same rhythm.

Typically the light units are arranged at least on two different sides of the display unit. The shape of the display unit is not essential from the point of view of the embodiments of the invention, but irrespective of the shape of the display unit, the light units are typically placed in the surroundings of the display unit, outside the display unit and the range of view, so that at least two separately controlled light unit groups are located in at least two different points of compass with respect to the display unit. Typically two light unit groups are placed on the opposite sides of the display unit, or at least at an angle of 90 degrees with respect to each other.

The light units can be located near the display unit, for instance so that they start extending immediately from the edge of the display unit, or further from the display unit. Typically the light units are permanently installed in the device, so that their location in relation to the display unit is fixed and cannot be changed. According to an embodiment, the light units are placed under a permeable or semi-permeable housing element, so that the light emitted therefrom can be detected through the housing element. According to another embodiment, that part of the housing element that covers the light units is provided with a permeable or semi-permeable element that is different from the rest of the housing element. According to an embodiment, the location of the light units is not fixed in relation to the device, but the light units are made movable, so that a light unit is placed for instance at the end of a telescoping shaft, in which case the light unit can, while the telescoping shaft is adjusted to its shortest possible position, be compactly installed in contact with the device. When the telescoping shaft is longest, the light unit can be detached from the device proper, in which case the operational environment producing sense stimuli to the user is enlarged and is not limited within the external dimensions of the small, portable device. The embodiment can also be realized for instance by means of light fiber optics. The telescoping shaft of the embodiment can be a fairly thin, plate-like element, nearly as wide as the device, that is opened up by pulling it from the inside of the device, or the telescoping shaft can be a thin shaft resembling a radio antenna and provided with one or several light units. Light units that are movable according to this embodiment are generally, particularly when transporting and storing the device, arranged on the device cover level, from where they can, when necessary—for instance for the use of an application—be pulled further out in order to achieve a wider view and a larger operational environment.

The view of a display unit can contain picture information, text, moving image, video information, multimedia or any other information shown in the display unit. By means of the light units described in embodiments, more information is produced in the view of the display unit, so that the light units or light unit groups located in a given direction with respect to the display unit view are adjusted in a certain way. The adjusted light units give a sense stimulus to the user's vision, typically in an area outside the assumed accurate vision range. The sense stimulus gives a hint or a reason to assume, i.e. it for instance indicates that the data shown in the display unit continues in the indicated direction, or that the user can proceed in the indicated direction, or that a target is approaching from the indicated direction in the view of the display unit, or that the searched target is located in the indicated direction, or that the view of the display unit is located at the indicated point of the whole system. According to an embodiment, the quality of the sense stimulus generated in the light units, such as intensity, color, velocity rate, frequency or the like, indicates, i.e. gives the user a hint as for the quality of the data, object or target located in the direction of the light unit. According to an embodiment, several indications can be given to the user simultaneously. The direction and quality of the indication are in relation to the view currently shown in the display unit. The indicated quality factor of the light units is a subjective observation, but on the other hand, the user is rapidly adjusted to new simple hints of his surroundings, and generally learns to utilize them very rapidly and effortlessly.

In the above examples, a small, transportable, portable device, in which the expansion of the display information according to the embodiments can be applied, can be for instance a mobile phone device, a game console, a PDA, personal digital assistant, a HMD, head mounted display, or the like. In particular, the embodiments of the invention are applied for small portable devices, where exactly the requirement of practical movability sets limits to the size of the device, to its external measures and weight.

1. A portable device provided with a display unit with information-indicating light units in the surroundings of said display unit, characterized in that the portable device comprises:
a controller for defining control commands on the basis of a display unit application and an instantaneous view shown in the display unit;
a light driver for controlling the information-indicating light units based on the control commands, such that the information-indicating light units are arranged to indicate information concerning an object located outside the current view of the display unit.

2. A device according to claim 1, characterized in that said device also includes a controller for generating control commands for the light units on the basis of the information transmitted by the display driver, to the light driver.

3. A device according to claim 1, characterized in that in the surroundings of the display unit, there are at least two light units or light unit groups formed of single light units, placed so that they are arranged at an angle of 90 degrees with respect to each other.

4. A device according to claims 12, characterized in that the light units are placed around the display unit.

5. A device according to claim 1, characterized in that it is provided with a light driver for controlling the light units or the light unit groups formed of single light units.

6. A device according to claim 1, characterized in that it is provided with a controller and a light driver for controlling the light units according to the application shown in the display unit.

7. A device according to claim 1, characterized in that it is provided with a controller for defining the control commands of the light units and for synchronizing the display unit with respect to the view.

8. A device according to claim 7, characterized in that it is provided with a light driver for controlling the functions and properties of the light units according to the control commands generated by the controller.

9. A method for improving information execution capability of a display unit of a portable device,
where in the surroundings of the display unit there are placed information indicating light units characterized in that the method comprises steps of
defining in a controller of the portable device a control command on the basis of a display unit application and an instantaneous view shown in the display unit in order to control the information-indicating light units;
controlling the information-indicating light units through a light driver based on the control command defined in the controller, such that information concerning an object located outside the current view of the display unit is indicated by means of the information-indicating light units.

10. A method according to claim 9, characterized in that in the controller, there are generated functional commands to the light driver in order to control the light units on the basis of the information of the view in the display unit, transmitted by the display driver and the application of the display unit.

11. A method according to claim 9, characterized in that the light units are arranged in the surroundings of the display unit, at an angle of 90 degrees with respect to each other, in order to indicate the direction, with respect to the view shown in the display unit, by means of the light units.

12. A method according to claims 9, characterized in that the light units are arranged in light unit groups, each of which groups can be separately controlled by the light driver.

13. A method according to claim 9, characterized in that in the display unit, there are shown objects under observation, and simultaneously the light units controlled by the fight driver are used for generating information in the view of the display.

14. A method according to claim 9, characterized in that the approaching of an object located outside the view of the display unit to the area of the view shown in the display unit is indicated by generating in the light driver a sense stimulus by means of those light units that are located in the same direction with respect to the view as the target in question.

15. A method according to claim 14, characterized in that the light driver is used for controlling a controllable light unit group, located in a given direction with respect to the view of the display unit, so that the intensity of the light units is increased as the object approaches the display unit.

16. A method according to claim 9, characterized in that the threatening factors of the game application represented in the view are indicated by adjusting the controllable light unit group that is located in the direction of the threatening factor with respect to the view by means of the light driver to emit a given wavelength of light, and possible proceeding directions are indicted by controlling the controllable light unit group that is located in the direction of the proceeding direction with respect to the view by means of the light driver to emit another given wavelength of light.

17. A method according to claim 9, characterized in that in the application shown in the view, the direction of a given searched target that is located outside the view, with respect to the view is indicated by activating the controllable light unit group located in the direction of the target by means of the light driver in a given way defined in the application.

18. A software for improving information execution capability of a display unit of a portable device, characterized in that it includes steps:
there is defined a given controllable light unit group composed of light units arranged in the surroundings of the display unit on the basis of the application and an instantaneous view shown in the display unit;
there are generated, on the basis of the application of the display unit, certain control commands in order to control the defined light unit group according to the application and the instantaneous view of the display unit and an object located outside the current view, and;
the generated control commands are transmitted to a light driver in order to control the defined light unit group for giving information about the object located outside the current view of the display unit.

19. A system for improving information execution capability of a display unit of a portable device, characterized in that it includes
software means for defining a controllable light unit group on the basis of the information of the application shown in the display unit and an object located outside the current view of the display unit, and;
software means for generating certain control commands on the basis of the information of the application of the display unit and the object located outside the current view of the display unit in order to control a given light unit group for giving information about the object located outside the current view of the display unit.
